(19) United States
(12) Patent Application Publication
(10) Pub. No.: US 2022/0361994 A1
(43) Pub. Date: Nov. 17, 2022

(54) ORAL CAVITY CLEANING DEVICE

(71) Applicant: Xiamen Solex High-Tech Industries Co., Ltd., Xiamen, Fujian (CN)

(72) Inventors: Zhaojin YIN, Xiamen, Fujian (CN); Shuixiu XIE, Xiamen, Fujian (CN); Chenying JIN, Xiamen, Fujian (CN); Mingfu ZHANG, Xiamen, Fujian (CN)

(21) Appl. No.: 17/619,376

(22) PCT Filed: Apr. 27, 2020
(86) PCT No.: PCT/CN2020/087149

§ 371 Date: Dec. 15, 2021

(30) Foreign Application Priority Data
Apr. 28, 2019 (CN) 201910349254.7

(51) Int. Cl. A61C 17/02; A61C 17/032; A61C 17/36; A46B 13/02

(52) U.S. Cl. CPC A61C 17/0208; A61C 17/032; A61C 17/36; A46B 13/023; A61C 2204/002

(57) ABSTRACT

An oral cavity cleaning device, which comprises a body, a water jet tip, a first motor, a second motor, a brush, and a water suction assembly. A rotating shaft extends out of an upper end surface of the body. The first motor drives the rotating shaft to vibrate to drive the brush to vibrate. The upper end surface of the body further comprises a water outlet, and the water jet tip is disposed on the upper end surface of the body and is in communication with the water outlet. Further, the water jet tip is disposed on a side of the brush facing a user, and the water jet tip is disposed below bristles of the brush. The second motor drives the water suction assembly to pump water from a built-in or external container, and water from a water passage disposed in the body sprays out of the water outlet and the water jet tip.

### FIELD OF THE DISCLOSURE

The present disclosure relates to a personal care device, and in particular relates to an oral cavity cleaning device.

### BACKGROUND OF THE DISCLOSURE

People pay more and more attention to oral cavity care with improvements in social living standards. People are no longer satisfied with cleaning oral cavities simply by brushing teeth. In recent years, products, such as electric toothbrushes and water flossers have emerged and are popular with consumers. The water flossers are devices in which water is drawn out of water containers to form a small water stream to be sprayed out. Therefore, a floss-like effect is formed to wash out food residue amongst teeth. Traditional products of the water flossers are independently used; users need to independently use the water flossers during a non-teeth-brushing time, which is time-consuming.

At the same time, when the electric toothbrushes are used, people need to fill a toothbrush cup with water and then cooperatively used together with the electric toothbrushes, which is also troublesome.

### BRIEF SUMMARY OF THE DISCLOSURE

The technical problems to be resolved of the present disclosure is to provide an oral cavity cleaning device which has independent teeth cleaning function and teeth brushing function and can perform supplemental teeth cleaning during a teeth brushing process.

In order to solve the technical problems, the present disclosure provides an oral cavity cleaning device, which comprises a body, a water jet tip, a first motor, a second motor, a brush, and a water suction assembly.

A rotating shaft extends out of an upper end surface of the body, the rotating shaft is driven to vibrate by the first motor and drives the brush to vibrate, the upper end surface of the body further comprises a water outlet, the water jet tip is disposed on the upper end surface of the body and is in communication with the water outlet, the water jet tip is disposed on a side of the brush facing a human body, a height of the water jet tip is disposed below bristles of the brush.

The second motor drives the water suction assembly to pump water from a built-in or external container to spray out of a water passage disposed in the body through the water outlet and the water jet tip.

In a preferred embodiment, the water suction assembly comprises a piston and a gear, and the gear is driven to rotate by an output shaft of the second motor and drives a reciprocating movement of the piston.

In a preferred embodiment, a water spout of the water jet tip is disposed on a side of the water jet tip facing the human body.

In a preferred embodiment, an external container is a water cup, a water bottle, a water pipe, or a water faucet.

In a preferred embodiment, a detachable connection relation is defined between the brush, the water jet tip, and the body.

The present disclosure further provides an oral cavity cleaning device, which comprises a body, a water jet tip, a dual output shaft motor, a brush, and a water suction assembly.

A rotating shaft extends out of an upper end surface of the body and is driven to vibrate by a first output shaft of the dual output shaft motor, the rotating shaft drives the brush to vibrate, the upper end surface of the body further comprises a water outlet, the water jet tip is disposed on the upper end surface of the body and is in communication with the water outlet, the water jet tip is disposed on a side of the brush facing a human body, a height of the water jet tip is disposed below bristles of the brush.

A second output shaft of the dual output shaft motor drives the water suction assembly to pump water from a built-in or external container to spray out of a water passage disposed in the body through the water outlet and the water jet tip.

In a preferred embodiment, the water suction assembly comprises a piston and a gear, and the gear is driven to rotate by the second output shaft of the dual output shaft motor and drives a reciprocating movement of the piston.

In a preferred embodiment, the gear is an end gear, the gear is coaxially disposed with a cam, and a connecting rod of the piston encompasses the cam. When a shaft of the piston disposed in a barrel of the piston reciprocates, pulse water is generated.

In a preferred embodiment, the body comprises a fixed base, a support base, and an inner cover, an up and down layout of one side of the support base is disposed with the first motor and a battery, an up and down layout of the other side is disposed with the second motor and the water suction assembly, and the inner cover enables an inner cavity of the body to define an upper water outlet section and a lower waterproof section through a sealing gasket.

In a preferred embodiment, a water spout of the water jet tip is disposed on a side of the water jet tip facing the human body.

In a preferred embodiment, an external container is a water cup, a water bottle, a water pipe, or a water faucet.

In a preferred embodiment, a detachable connection relation is defined between the brush, the water jet tip, and the body.

Compared with the existing techniques, the technical solution has the following advantages.

The present disclosure discloses the oral cavity cleaning device. The water jet tip and the brush are two independent parts, so that the oral cavity cleaning device can have independent teeth cleaning function and teeth brushing function. In addition, the water jet tip is disposed on a side of the brush adjacent to the human body. Therefore, when the user brushes teeth, the brush and the water jet tip can be installed at the same time, and the water jet tip will also spray water to supplemental teeth cleaning during a teeth brushing process, so that the oral cavity is more thoroughly cleaned. Further, the water jet tip is independent from the brush, so that the water from the water jet tip will not be shuttered or restricted by the brush.

In traditional oral cavity cleaning devices, the water jet tip is disposed on the brush, which can neither ensure that the water is not shuttered during the teeth brushing process, nor enable a teeth cleaning operation to be independently performed, which is very inconvenient. The technical solution of the present disclosure perfectly solves this problem.

### BRIEF DESCRIPTION OF THE DRAWINGS

FIG. 1 illustrates a side view of an appearance of an oral cavity cleaning device of a preferred embodiment 1 of the present disclosure;

FIG. 2 illustrates a cross-sectional view of the appearance of the oral cavity cleaning device of the preferred embodiment 1 of the present disclosure;

FIG. 3 illustrates an exploded view of a structure of the oral cavity cleaning device of the preferred embodiment 1 of the present disclosure;

FIG. 4 illustrates an in-use view of the oral cavity cleaning device of the preferred embodiment 1 of the present disclosure;

FIG. 5 illustrates another in-use view of the oral cavity cleaning device of the preferred embodiment 1 of the present disclosure;

FIG. 6 illustrates a schematic view of the oral cavity cleaning device of the preferred embodiment 1 of the present disclosure in a teeth cleaning mode (an internal structure is simplified);

FIG. 7 illustrates a schematic view of the oral cavity cleaning device of the preferred embodiment 1 of the present disclosure in a brushing mode (the internal structure is simplified);

FIG. 8 illustrates a cross-sectional view of a structure of an oral cavity cleaning device of a preferred embodiment 2 of the present disclosure.

### DETAILED DESCRIPTION OF THE EMBODIMENTS

The present disclosure will be further clarified below in combination with the accompanying drawings and embodiments.

### Embodiment 1

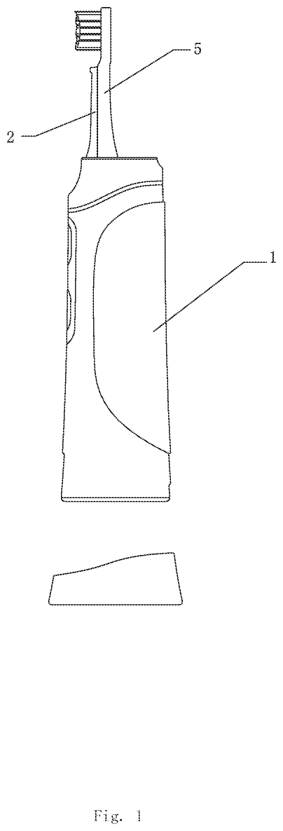

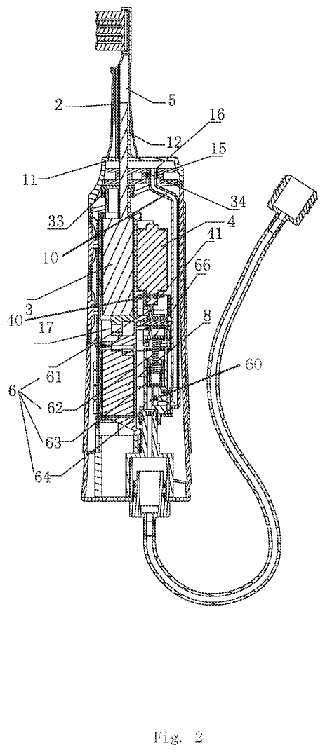

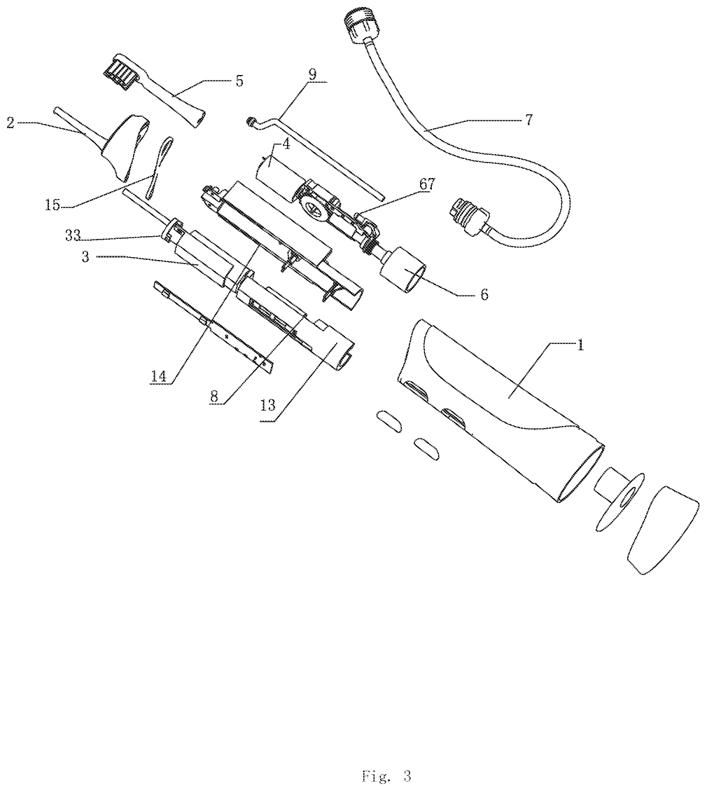

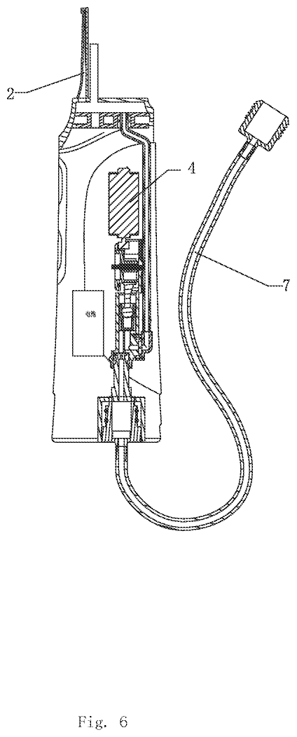

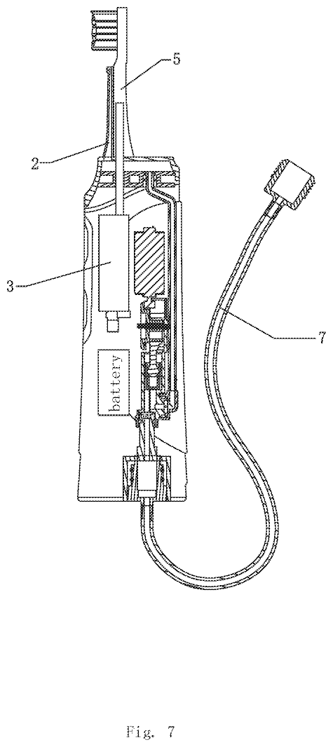

Referring to FIGS. 1-7, the embodiment provides an oral cavity cleaning device, which comprises a body 1, a water jet tip 2, a first motor 3, a second motor 4, a brush 5, and a water suction assembly 6.

A rotating shaft 12 extends out of an upper end surface of the body 1. The first motor 3 drives the rotating shaft 12 to vibrate to drive the brush 5 to vibrate. The upper end surface of the body 1 further comprises a water outlet 11, and the water jet tip 2 is disposed on the upper end surface of the body 1 and is in communication with the water outlet 11. Further, the water jet tip 2 is disposed on a side of the brush 5 facing a human body, and a height of the water jet tip 2 is disposed below bristles of the brush 5.

The second motor 4 drives the water suction assembly 6 to pump water from a built-in or external container, and water from a water passage disposed in the body 1 sprays out of the water outlet 11 and the water jet tip 2.

In the oral cavity cleaning device, the water jet tip 2 and the brush 5 are two independent parts, so that the oral cavity cleaning device can have independent teeth cleaning function and teeth brushing function. In addition, the water jet tip 2 is disposed on a side of the brush 5 adjacent to the human body. Therefore, when the user brushes teeth, the brush 5 and the water jet tip 2 can be installed at the same time, and the water jet tip 2 will also spray water to supplemental teeth cleaning during a teeth brushing process, so that the oral cavity is more thoroughly cleaned. In addition, the water jet tip 2 is independent from the brush 5, so that the water from the water jet tip 2 will not be shuttered or restricted by the brush 5.

In this embodiment, the water suction assembly 6 comprises a gear 61, a connecting rod 62, a shaft 63 of a piston, and a barrel 64 of the piston. The gear 61 is driven to rotate by an output shaft of the second motor 4 to drive the shaft 63 to reciprocate in the barrel 64 by the connecting rod 62. During a reciprocating movement, the shaft 63 enables the water to be sucked in and then sprayed out to form pulse water. In detail, the gear 61 is engaged with a driving gear 41 disposed on the output shaft of the second motor 4; after the second motor 4 is started, the gear 61 is driven to rotate.

In this embodiment, the gear 61 is an end gear. The gear 61 is coaxially disposed with a cam 66, and an upper part of the connecting rod 62 encompasses the cam 66.

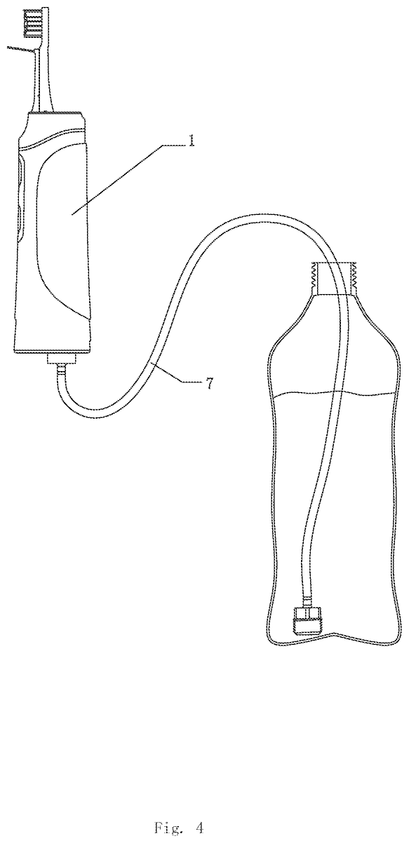

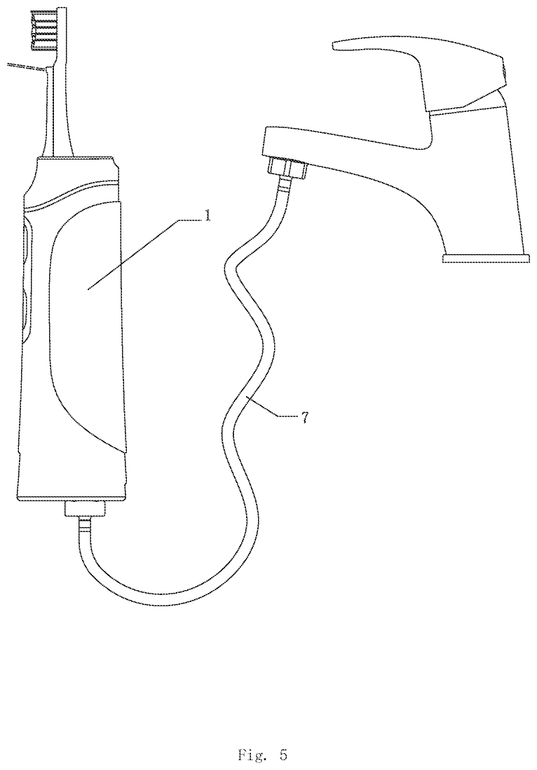

In this embodiment, a water container is external, and a bottle of FIG. 4 or a faucet of FIG. 5 can be selected. In order to connect to an external container, a bottom of the body 1 needs to be connected to the external container through an external water pipe 7.

When in a teeth cleaning state, the second motor 4 is started, the gear 41 is engaged with the gear 61 to drive the gear 61 to rotate, the cam 66 rotates synchronously, and the shaft 63 is driven to reciprocate and to move up and down in the barrel 64 through the connecting rod 62 to enable the water to be sucked in and then sprayed out to form the pulse water, which is sprayed out of a water spout of the water jet tip 2 through a built-in water pipe 9.

In addition, the water spout of the water jet tip 2 is disposed on a side of the water jet tip 2 facing the human body. In this way, a direction of the water is roughly the same as a teeth brushing direction, and a teeth brushing part can be impacted by the water.

A detachable connection relation is defined between the brush 5, the water jet tip 2, and the body 1. In this way, the brush 5 and the water jet tip 2 can be used in combination or independently, so that the oral cavity cleaning device can be independently used as a water flosser or as an electric toothbrush.

In this embodiment, the first motor 3 is an ultrasonic motor.

In this embodiment, the body 1 further comprises a fixed base 13, a support base 14, and an inner cover 15. An up and down layout of one side of the support base 14 is disposed with the first motor 3 and a battery 8, and an up and down layout of the other side is disposed with the second motor 4 and the water suction assembly 6. An upper end of the built-in water pipe 9 is tightly connected to an inner side of the inner cover 15, and a lower end and a water outlet joint 67. The rotating shaft 12 of the first motor 3 passes through a sealing gasket 33 and extends out of the inner cover 15. The inner cover 15 enables an inner cavity of the body 1 to define an upper water outlet section and a lower waterproof section through sealing gaskets 33 and 34.

Due to a layout design of the fixed base 13, the support base 14, and the inner cover 15 in this embodiment, the structure is compact, and the safety assurance is excellent.

### Embodiment 2

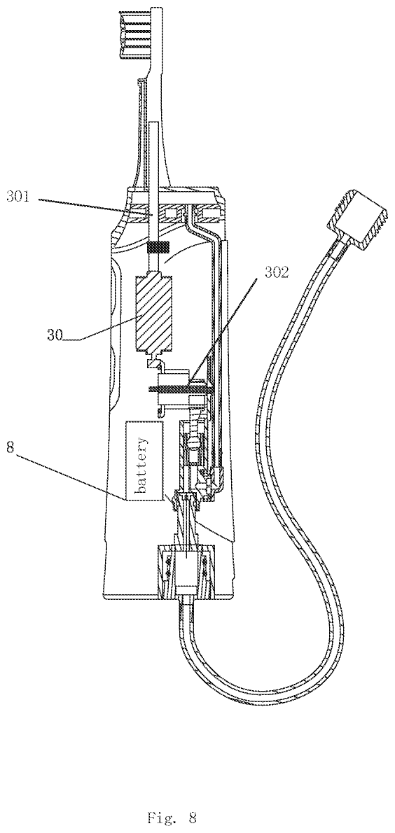

Referring to FIG. 8, this embodiment differs from Embodiment 1 in that a dual output shaft motor 8 is used in this embodiment to replace the first motor and the second motor in Embodiment 1.

The rotating shaft 12 extends out of the upper end surface of the body 1 and is driven to vibrate by a first output shaft of the dual output shaft motor 8. The rotating shaft 12 drives the brush to vibrate. The upper end surface of the body 1 is further disposed with the water outlet 11, and the water jet tip 2 is disposed on the upper end surface of the body 1 and is in communication with the water outlet 11. Further, the water jet tip 2 is disposed on the side of the brush 5 facing the human body, and the height of the water jet tip 2 is disposed below the bristles of the brush 5.

A second output shaft of the dual output shaft motor 8 drives the water suction assembly 6 to draw the water from the built-in or external container, which is sprayed out from the water passage disposed in the body through the water outlet and the water jet tip.

The remaining parts are the same as Embodiment 1 and will not be further described here.

The aforementioned embodiments are merely some preferred embodiments of the present disclosure, and the scope of the disclosure is not limited thereto. Thus, it is intended that the present disclosure cover any modifications and variations of the present disclosure. Therefore, the scope of the present disclosure should be defined by the scope of the claims.

### INDUSTRIAL APPLICABILITY

The oral cavity cleaning device of the present disclosure independently comprises the teeth cleaning device and the teeth brushing device and can perform the supplemental teeth cleaning during the teeth brushing process or perform teeth cleaning and teeth brushing in sequence or independently. The structure of the present disclosure is compact, the application is safe, which has a good industrial applicability.

1. An oral cavity cleaning device, comprising:
a body,
a water jet tip,
a first motor,
a second motor,
a brush, and
a water suction assembly, wherein:
a rotating shaft extends out of an upper end surface of the body,
the rotating shaft is driven to vibrate by the first motor and drives the brush to vibrate,
the upper end surface of the body comprises a water outlet,
the water jet tip is disposed on the upper end surface of the body and is in communication with the water outlet,
the water jet tip is disposed on a side of the brush facing a user,
the water jet tip is disposed below bristles of the brush, and
the second motor drives the water suction assembly to pump water from a built-in container or an external container to spray out of a water passage disposed in the body through the water outlet and the water jet tip.

2. The oral cavity cleaning device according to claim 1, wherein:
the water suction assembly comprises a piston and a gear, and
the gear is driven to rotate by an output shaft of the second motor and drives a reciprocating movement of the piston.

3. The oral cavity cleaning device according to claim 2, wherein:
the gear is an end gear,
the gear is coaxially disposed with a cam,
a connecting rod of the piston encompasses the cam, and
when a shaft of the piston disposed in a barrel of the piston reciprocates, pulse water is generated.

4. The oral cavity cleaning device according to claim 3, wherein:
the body comprises a fixed base, a support base, and an inner cover,
an up and down layout of one side of the support base is disposed with the first motor and a battery,
an up and down layout of the other side of the support base is disposed with the second motor and the water suction assembly, and
the inner cover enables an inner cavity of the body to define an upper water outlet section and a lower waterproof section through a sealing gasket.

5. The oral cavity cleaning device according to claim 1, wherein a water spout of the water jet tip is disposed on a side of the water jet tip facing the user.

6. The oral cavity cleaning device according to claim 1, wherein the external container is a water cup, a water bottle, a water pipe, or a water faucet.

7. The oral cavity cleaning device according to claim 1, wherein a detachable connection relation is defined between the brush, the water jet tip, and the body.

8. An oral cavity cleaning device, comprising:
a body,
a water jet tip,
a dual output shaft motor,
a brush, and
a water suction assembly, wherein:
a rotating shaft extends out of an upper end surface of the body,
the rotating shaft is driven to vibrate by a first output shaft of the dual output shaft motor,
the rotating shaft drives the brush to vibrate,
the upper end surface of the body comprises a water outlet,
the water jet tip is disposed on the upper end surface of the body and is in communication with the water outlet,
the water jet tip is disposed on a side of the brush facing a user,
the water jet tip is disposed below bristles of the brush, and
a second output shaft of the dual output shaft motor drives the water suction assembly to pump water from a built-in container or an external container to spray out of a water passage disposed in the body through the water outlet and the water jet tip.

9. The oral cavity cleaning device according to claim 8, wherein:
the water suction assembly comprises a piston and a gear, and
the gear is driven to rotate by the second output shaft and drives a reciprocating movement of the piston.

10. The oral cavity cleaning device according to claim 8, wherein a water spout of the water jet tip is disposed on a side of the water jet tip facing the user.

11. The oral cavity cleaning device according to claim 8, wherein the external container is a water cup, a water bottle, a water pipe, or a water faucet.

12. The oral cavity cleaning device according to claim 8, wherein a detachable connection relation is defined between the brush, the water jet tip, and the body.

13. The oral cavity cleaning device according to claim 9, wherein:
the gear is an end gear,
the gear is coaxially disposed with a cam,
a connecting rod of the piston encompasses the cam, and
when a shaft of the piston disposed in a barrel of the piston reciprocates, pulse water is generated.

14. The oral cavity cleaning device according to claim 10, wherein:
the body comprises a fixed base, a support base, and an inner cover,
an up and down layout of one side of the support base is disposed with the first output shaft of the dual output shaft motor and a battery,
an up and down layout of the other side of the support base is disposed with the second output shaft of the dual output shaft motor and the water suction assembly, and
the inner cover enables an inner cavity of the body to define an upper water outlet section and a lower waterproof section through a sealing gasket.
